(19) United States
(12) Patent Application Publication
(10) Pub. No.: US 2005/0052474 A1
(43) Pub. Date: Mar. 10, 2005

(54) Data visualisation system and method

(76) Inventor: Andrew. John Cardno, Las Vegas, NV (US)

Correspondence Address: COMPUDIGM SERVICES INC., 1550 W. Horizon Ridge Parkway, SUITE A, Henderson, NV, 89012, US

(21) Appl. No.: 10/642,789

(22) Filed: Aug. 19, 2003

(51) Int. Cl. G09G 5/10

(52) U.S. Cl. 345/690

(57) ABSTRACT

The invention provides a data visualization system comprising a data memory in which is maintained one or more fact data sets comprising an identifier and one or more attribute and one or more finite element data sets wherein the members of each finite element data set define the range of possible values for at least one attribute of at least one fact data set; a retrieval component arranged to retrieve one or more data sets from the memory; and a display component arranged to display a graphical representation of a chosen subset of the set of all fact data sets in the memory as a series of data values. The invention also provides a related method and computer program.

### FIELD OF INVENTION

The invention relates to a data visualisation system and method, particularly but not solely designed to graphically describe or represent information contained within a data warehouse in a user friendly way.

### BACKGROUND TO INVENTION

The low cost of data storage hardware has led to the collection of large volumes of data. Merchants, for example, generate and collect large volumes of data during the course of their business. To compete effectively, it is necessary for a merchant to be able to identify and use information hidden in the collected data. Typically merchants and other companies collect trading and other data and store this data in a data warehouse.

Some software products exist which are intended to allow merchants to see visual reports of data stored in such data warehouses. However, the visualisations produced by such reporting tools are often confusing and difficult to follow.

It would be particularly advantageous to provide a system which enables a user to obtain meaningful information from a data warehouse and have presented to a user representations of this data in a more intuitive and user friendly way.

### SUMMARY OF INVENTION

In broad terms in one form the invention provides a data visualisation system comprising a data memory in which is maintained one or more fact data sets comprising an identifier and one or more attributes and one or more finite element data sets wherein the members of each finite element data set define the range of possible values for at least one attribute of at least one fact data set; a retrieval component arranged to retrieve one or more data sets from the memory; and a display component arranged to display a graphical representation of a chosen subset of the set of all fact data sets in the memory as a series of data values.

In broad terms in another form the invention provides a data visualisation computer program comprising a series of fact data sets comprising an identifier and one or more attributes stored in a data memory, and one or more finite element data sets wherein the members of each finite data set defines a range of possible values for at least one attribute of at least one fact data set maintained in a data memory, a retrieval component arranged to retrieve one or more data sets from the memory; and a display component arranged to display a graphical representation of a chosen subset of the set of all fact data sets in the memory as a series of data values.

In broad terms in another form the invention provides a method of data visualisation comprising the steps of maintaining in a data memory one or more fact data sets comprising an identifier and one or more finite element data sets wherein the members of each finite data set defines the range of possible values for at least one attribute of at least one fact data set; retrieving one or more data sets from the memory; and displaying a graphical representation of a chosen subset of the set of all fact data sets in the memory as a series of data values.

### BRIEF DESCRIPTION OF THE FIGURES

Preferred forms of the data visualisation system and method will now be described with reference to the accompanying Figures in which:

FIG. 1 shows a block diagram of a system in which one form of the invention may be implemented;

FIG. 2 shows the preferred system architecture of hardware on which a present invention may be implemented;

FIG. 3 is a preferred representation generated in accordance with the invention;

FIG. 4 is a preferred representation generated in accordance with the invention;

FIG. 5 is a preferred representation generated in accordance with the invention including contoured data;

FIG. 6 is a further preferred representation generated in accordance with the invention including contoured data; and

FIG. 7 is a further preferred representation generated in accordance with the invention.

### DETAILED DESCRIPTION OF PREFERRED FORMS

The preferred forms of the system, method, and computer program according to the invention will now be described in detail with reference to the accompanying figures by way of example only.

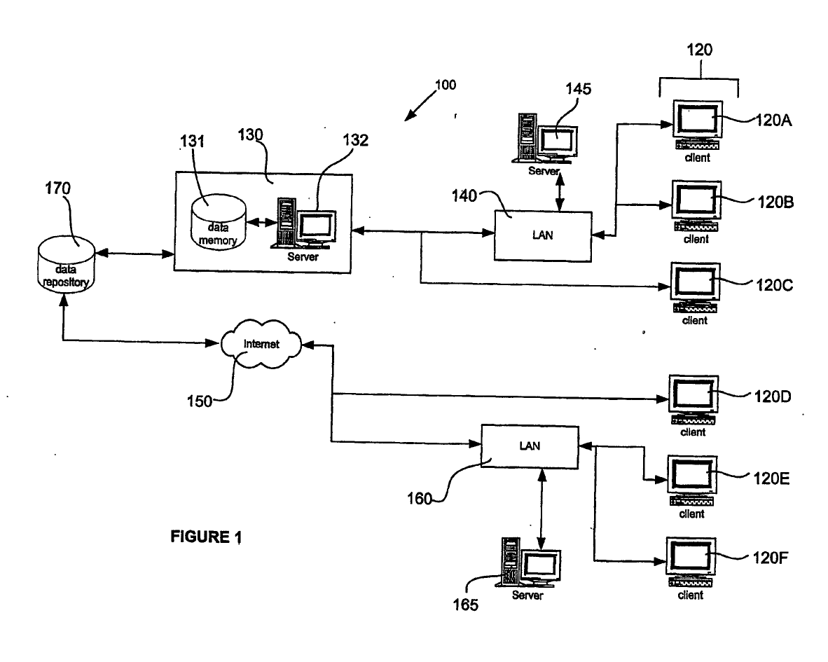

FIG. 1 illustrates a block diagram of the preferred system 100 in which the data visualisation system, method or computer program of the present invention may be implemented. The system includes one or more clients 120, for example 120A, 120B, 120C, 120D, 120E and 120F, which each may comprise a personal computer or workstation described below or alternatively any computing device. Each client 120 is interfaced to a workstation 130 as shown in FIG. 1. Each client 120 could be connected directly to the workstation 130, could be connected through a local area network or LAN, or could be connected through the Internet.

Clients 120A and 120B, for example, are connected to a network 140, such as a local area network or LAN. The network 140 could be connected to a suitable network server 145 and communicate with the workstation 130 as shown. Client 120C is shown connected directly to the workstation 130. Clients 120D, 120E and 120F are shown connected to the workstation 130 through the Internet 150. Client 120D is shown as connected to the Internet 150 with a dial-up or other suitable connection and clients 120E and 120F are shown connected to a network 160 such as a local area network or LAN, the network 160 connected to a suitable network server 165.

The preferred system 100 further comprises a data repository 170, for example a data warehouse maintained in a memory. It is envisaged that the data repository may alternatively comprise a single database, a collection of databases, or a data mart. The preferred data repository 170 includes data from a variety of sources, and could include data representing interactions between customers and merchants.

Typically, a merchant will operate in a commercial premises or store from which a customer purchases goods or services. As a customer interacts with a merchant, the interaction generates interaction data which is then migrated to the data repository 170. In one preferred form, the workstation 130 operates under the control of appropriate operating and application software having a data memory 131 connected to a server 132. The invention is arranged to retrieve data from the data repository 170, process the data with the server 132 and to display the data on a client workstation 120 as described below.

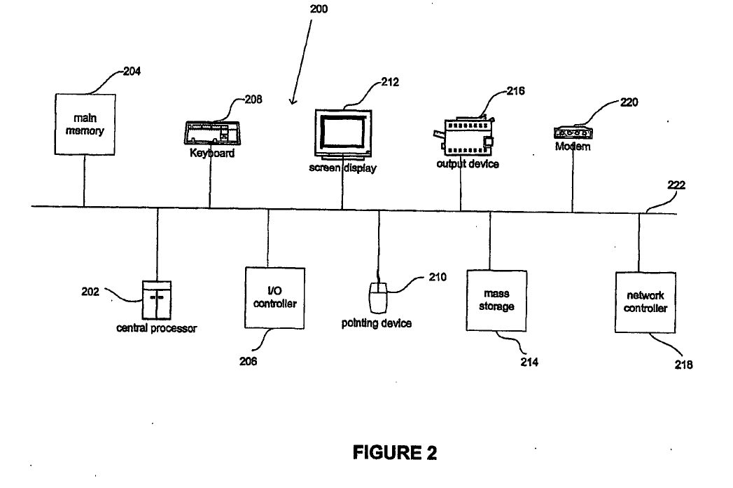

FIG. 2 shows the preferred system architecture of a client 120 or workstation 130. The computer system 200 typically comprises a central processor 202, a main memory 204 for example RAM and an input/output controller 206. The computer system 200 also comprises peripherals such as a keyboard 208, a pointing device 210 for example a mouse, track ball or touch pad, a display or screen device 212, a mass storage memory 214 for example a hard disk, floppy disk or optical disc, and an output device 216 for example a printer. The system 200 could also include a network interface card or controller 218 and/or a modem 220. The individual components of the system 200 could communicate through a system bus 222, or alternatively could be distributed from each other and interfaced over a network.

It is envisaged that the data stored in the data repository 170 could be stored in mass storage 214 of the workstation 130, in a client workstation 120, or on a further data memory interfaced to the workstation 130 and/or client 120.

Data stored in the data repository 170 could constitute a data warehouse. A data warehouse is comprised of one or more databases. The one or more databases comprised of two types of table: FACT tables and DIMENSION tables.

A FACT table is a table on which queries can be performed. These facts could include individual interactions involving various entities such as companies or merchants. A FACT table commonly stores large amounts of information and is essentially comprised of source data columns.

A DIMENSION table is a table which defines meaningful ways of separating data contained within a fact table. These attributes or dimensions could include for example a sector identifier representing the industry in which the entity or company operates, and a location identifier identifying the place of operation.

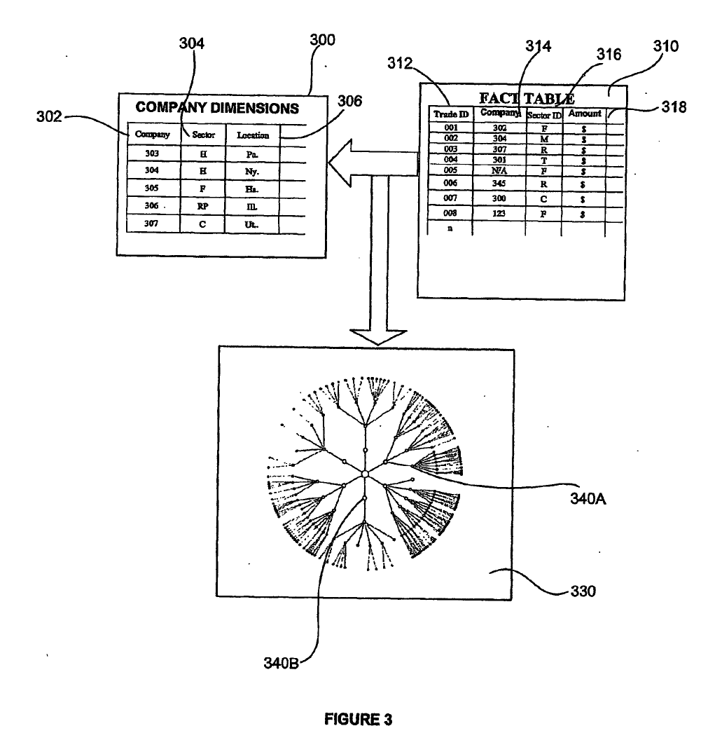

FIG. 3 illustrates one preferred representation generated in accordance with the invention in which the data repository 170 includes a plurality of tables, for example COMPANY DIMENSIONS table 300 and FACT table 310. COMPANY DIMENSIONS table 300 could include a plurality of records, each record representing a company, organisation, merchant or other entity. The company dimensions table could include various fields for example company identifier 302, sector identifier 304 and location identifier 306.

The FACT table 310 could include a plurality of records, each record representing a different interaction involving a company from the COMPANY DIMENSIONS table 300. The FACT table 310 could include various fields, for example, a trade or interaction identifier 312, a company identifier 314, a sector identifier 316 and a monetary value 318.

A retrieval component, for example, a query processor or search engine could obtain user queries and apply these queries to the data table stored in the data repository 170.

A display component could display to a user a graphical representation of the results of such queries. The display could be a software component arranged to display graphic images to a user or the display could be a hardware component such as a computer screen. The invention provides a place for each value/dimension to be placed within the representation. The graphical representation may represent abstract or physical structures and may be represented in 2, 3 to n dimensional space.

The graphical representation may comprise a hierarchical layout 330 as shown in FIG. 3. The hierarchical layout 330 could include a series of nodes displayed as a connected graph. Each node could represent an individual company or entity, for example 340A and 340B. The position of each node within the representation could be based on the sector 304, the location 306 or some other attribute of the company 302. Companies in the same sector 304 could be grouped together and/or companies in the same location 306 could be grouped together. The hierarchical structure 330 enables separation of data and provides a place or location around which further data could be presented.

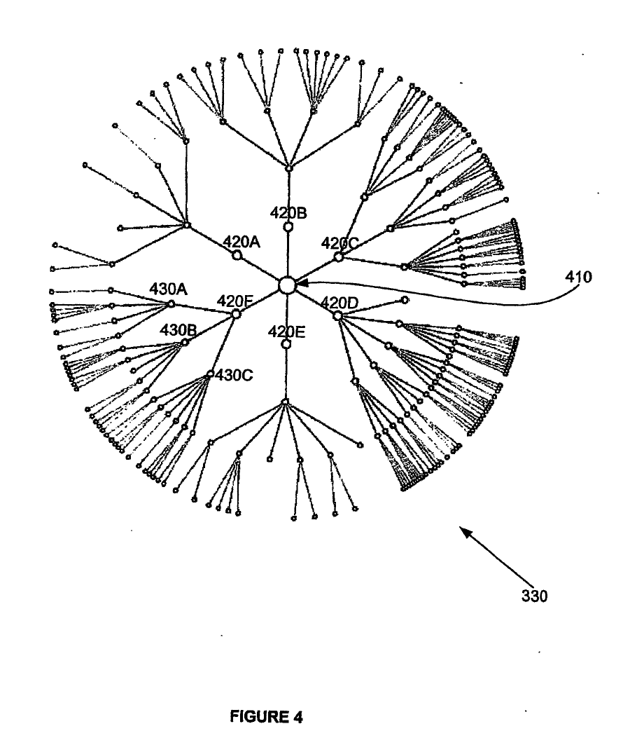

FIG. 4 shows the hierarchical represenation 330 of FIG. 3 in more detail. The central node 410 of the representation 330 represents all relevant data from the data warehouse before any dimensions have been applied to it. Dimensions are applied to the data in order to seperate out data of interest. The inner circle of nodes 420A, 420B, 420C, 420D, 420E, and 420F represent the division of data after a first dimension has been applied to the data. For example, if the first dimension applied was “Sector” then node 420A may represent Consumer, node 420B may represent Healthcare, node 420C may represent Finance, node 420D may represent Resources, node 420E may represent Media, and 420F may represent Technology.

The second, third and fourth circles of nodes may represent the division of data which results from applying successive dimensions to the data. Thus the dimensions allow for the sorting and presentation of the data from the data warehouse. The second circle of nodes could, for example, represent location. The data at each node in the inner circle would then be divided again according to location. For example the data included with node 420F could be further divided into nodes 430A, 430B, and 430C, where 430A represents Australia, 430B represents Canada, and 430C represents the United States.

In an embodiment such as the one described above, a user may be especially interested in the children of a particular node, for example, 420F in FIG. 4 which represents the Technology sector. Or a node may have many children making it difficult to see the exact configuration for all such children and grandchildren, as is the case for node 430D in FIG. 4 for example. In cases like these a user may select a node of interest and the method, system or computer program of the invention may allow the user to view a new hierarchical representation with the selected node at the centre of the configuration and the children and grandchildren of that node arranged around it in a configuration similar to that of the parent graph.

For a data representation similar to that of the preferred form illustrated in FIG. 4, there are cases where the dimensions applied to the data could be applied in any order. This is the case in the example described above. The dimension Sector is applied first and the dimension Location is applied next. It would be just as possible to apply the Location dimension first, followed by Sector. The preference of the user in selecting the first dimension to apply will depend on the focus of the user's interest in the data. In a case such as this, the user may wish to view the data both ways. The user may, therefore, select a node in a first representation and dynamically change it's position in the hierarchy, by dragging it with a mouse for example, or by changing options on a menu or form. The invention may then redisplay the representation with the nodes arranged according to the newly specified hierarchy of dimensions.

However, in a representation similar to that illustrated in FIG. 4, it is also possible that the succesive circles of nodes may have a logical relationship which makes most sense when presented in sequence. For example, the first inner circle could represent country, the second circle could represent state, the third city, and the fourth suburb. In this case the order of the successive layers of nodes could be firm as it is not desirable to alter the order in which the dimensions are applied. The circular graph generated by one or more of the preferred forms of the invention could also form a spatial substrate on which to superimpose contoured data For example, once the nodes of the graph are arranged in a pre-defined space within the circular configuration, the nodes could be used as data points about which to contour supplementary data which may be, for example, one of various key performance indicators or KPIs retrieved from the data repository 170, for example, revenue, turnover, sales, gross profit, net profit, gross margin of return on inventory investment, net margin return on inventory investment, return on net assets and/or loyalty sales data. Such contouring is described in our patent specification WO 00/77682 to Compudigm International Limited dated 14 Jun. 2000.

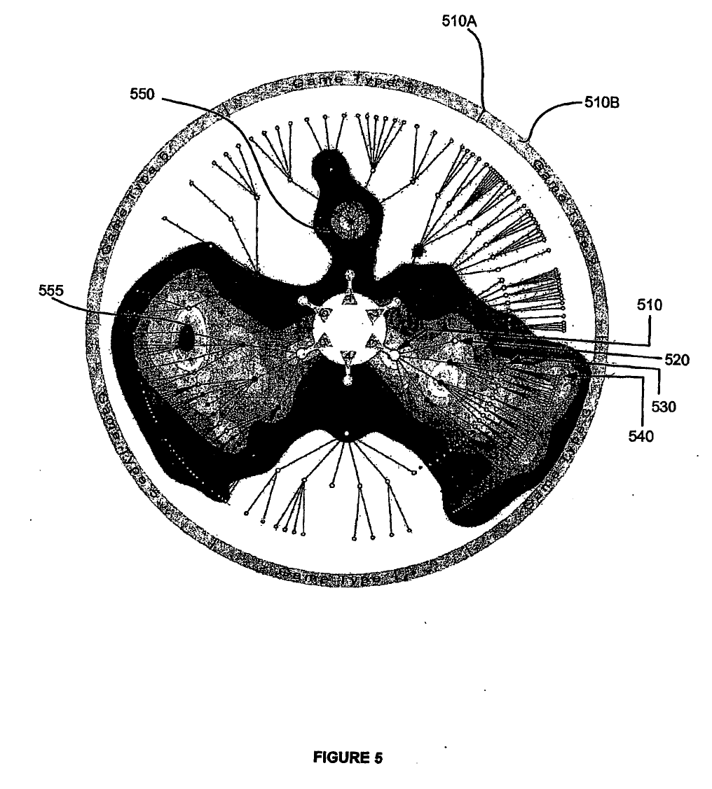

FIG. 5 illustrates a graph of the same basic form as the representation illustrated in FIG. 4. In the example illustrated in FIG. 5 the data of interest relates to gaming machines located, for example, in casinos, bars and pubs on which players may bet by paying amounts made up of various denominations into one or more slots on the machine. The first dimension which has been applied to the relevent data in this example is “Game Type”. The centermost node of data may then be divided into an inner circle of n nodes, for example 510, where n is the number of divisions which result from applying the first dimension. The graph area may be divided accordingly into a series of n segments The segments of the representation may be delineated along the circumference of the representation with dividers 510A and/or labels 510B.

In the example illustrated in FIG. 5, three further dimensions have been applied to the data represented in FIG. 5 so there are three further layers to the circular graph. Nodes in the first outer circle, for example 520, could represent different game names. Nodes in the second outer circle, for example 530, could represent different denominations which are payed into the machines. Nodes in the final outer circle, for example 540, could represent particular slots on the machine which can receive bets from players.

In this representation an additional data field of interest is modeled around the various nodes in the form of contours, for example 550 and 555. The contours may represent a KPI such as percentage increase in hand pull over a chosen month for the particular machines identified by each node in the graph.

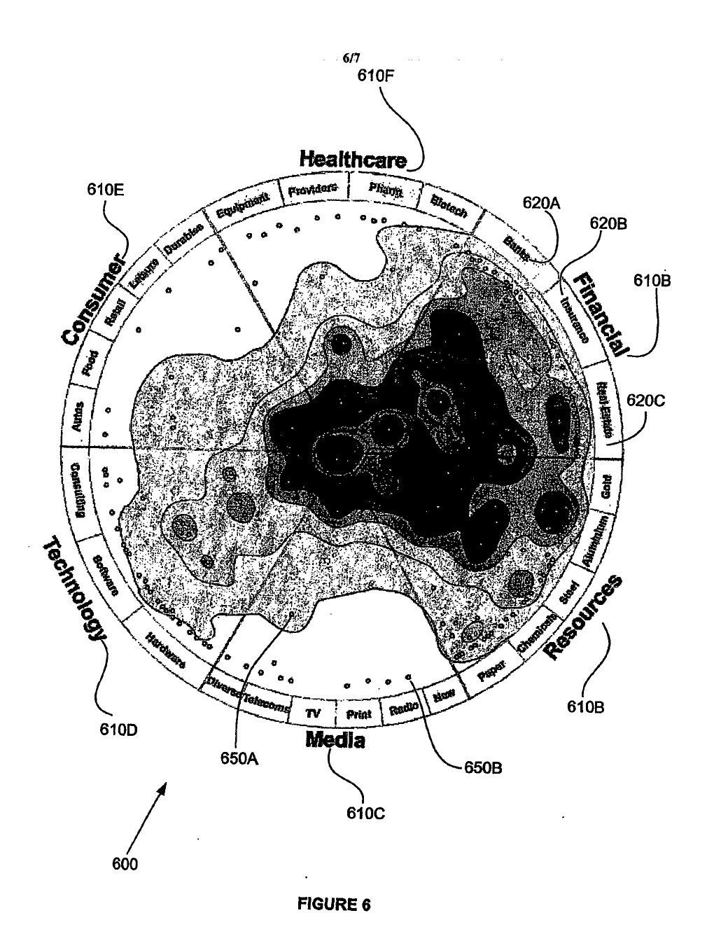

The display component could be further arranged to display a circular graph to a user such as that illustrated in FIG. 6 at 600. Each data value of interest could be displayed a certain distance from the centre point of the circle. The distance could be based on some measure of importance, for example, if the data value represented a company the measure of importance may be company size or average annual turnover. Important companies could be grouped nearer the centre of the circle, whereas less important companies could be placed at the periphery. The circular graph could again be divided equally between the output values of a given dimension. For example, the graph could be divided into a series of segments according to the application of a dimension “Sector”, each segment in the representation corresponding to a different industry sector in which each company operates. Examples of sectors include Financial 610A, Resources 610B, Media 610C, Technology 610D, Consumer 610E, and Healthcare 610F sectors. Each of these segments could be further divided into sub-segments representing industry sub-sectors. For example, the financial sector could be further divided into banks 620A, insurance 620B, and real estate 620C. Nodes representing companies could be positioned within the circular graph, for example as shown at 650A and 650B. Each company representation could be placed in a segment of the circular graph based on the sector identifier of the company.

Once the companies are arranged in a pre-defined space within the circular configuration, their locations could again be used as data points about which to contour various key performance indicators or KPIs for that company retrieved from the data repository 170.

The circular graph shown at 600 provides two axes of similarity, namely sector and importance. Patterns are more likely to be meaningful to a user since companies that are close together in the display will be in similar sectors and be of similar importance to the market. It will be appreciated that the invention could display any dimension of data on any substrate. FIG. 6 merely shows one example.

In the previous examples, the invention has divided the circular representations of the data into n equal segments depending on the number of possible values which exist for the first dimension applied to the data. However, the invention also encompasses the production of other representations of data which are variations on the basic system and method illustrated by the above examples. It will be appreciated that other configurations are possible and may be produced by the method, system and computer program of the present invention.

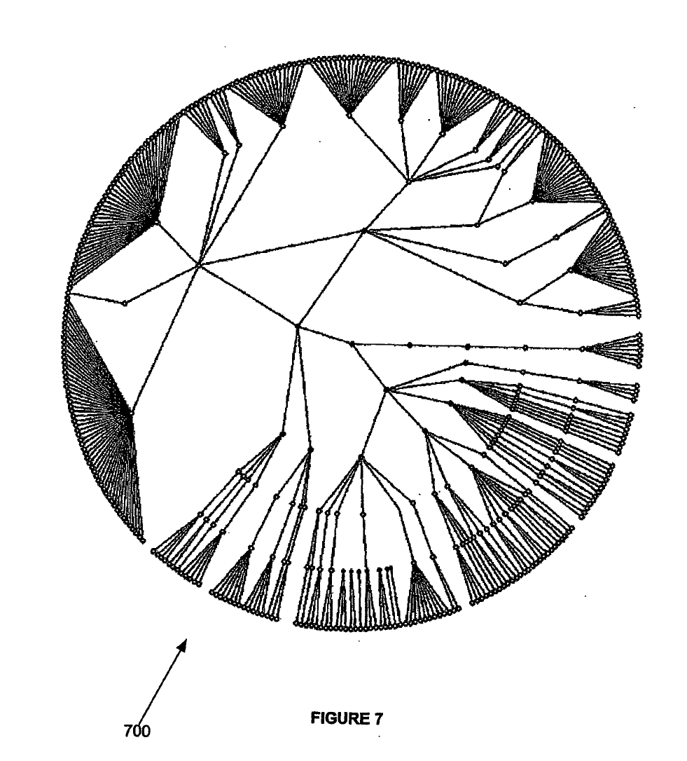

FIG. 7 illustrates a configuration of data nodes 700 according to the invention wherein instead of dividing the representation into equal sized segments based on the number of nodes in the inner circle, the outermost nodes have been evenly spaced around the circumference of the representation.

The foregoing describes the invention including preferred forms thereof. Alterations and modifications as will be obvious to those skilled in the art are intended to be incorporated in the scope hereof, as defined by the accompanying claims.

1. A data visualisation system comprising:
a data memory in which is maintained one or more fact data sets comprising an identifier and one or more attributes, and one or more finite element data sets wherein the members of each finite data set defines the range of possible values for at least one attribute of at least one fact data set;
a retrieval component arranged to retrieve one or more data sets from the memory; and
a display component arranged to display a graphical representation of a chosen subset of the set of all fact data sets in the memory as a series of data values.

2. A data visualisation system as claimed in claim 1 wherein the graphical representation has a substantially circular configuration.

3. A data visualisation system as claimed in claim 1 wherein the graphical representation comprises a circular graph.

4. A data visualisation system as claimed in claim 2, arranged to retrieve one finite data set and divide the graphical representation into two or more segments, each segment matching a member of one of the finite element sets and an attribute of at least one member of the chosen subset of the set of all fact data sets.

5. A data visualisation system as claimed in claim 4 further arranged to retrieve a further finite element data set and divide each segment into one or more sub-segments, each sub-segment matching a member of the further finite data set and an attribute of at least one of the members of the chosen subset of the set of all fact data sets included in the segment.

6. A data visualisation system as claimed in claim 2 where the chosen subset of the set of all fact data sets is represented by one or more nodes within the representation

7. A data visualisation system as claimed in claim 6 wherein the graphical representation is arranged to create a new circle of nodes on the outer circumference of the graph whenever the graph divides, the number of nodes equal to the number of new segments, and each node in the new circle substantially the same distance from the centre of the graph.

8. A data visualisation system as claimed in claim 6 arranged to superimpose contoured data representations around each node in the representation such that each data point is displayed as a local maximum.

9. A data visualisation computer system comprising:
one or more fact data sets comprising an identifier and one or more attributes, and one or more finite element data sets wherein the members of each finite data set defines the range of possible values for at least one attribute of at least one fact data set all data sets maintained in a data memory;
a retrieval component arranged to retrieve one or more data sets from the memory; and
a display component arranged to display a graphical representation of a chosen subset of the set of all fact data sets in the memory as a series of data values.

10. A data visualisation computer program as claimed in claim 9 wherein the graphical representation has a substantially circular configuration.

11. A data visualisation computer program as claimed in claim 9 wherein the graphical representation comprises a circular graph.

12. A data visualisation computer program as claimed in claim 10, arranged to retrieve one finite data set and divide the graphical representation into two or more segments, each segment matching a member of one of the finite element sets and an attribute of at least one member of the chosen subset of the set of all fact data sets.

13. A data visualisation computer program as claimed in claim 12 further arranged to retrieve a further finite element data set and divide each segment into one or more sub-segments, each subsegment matching a member of the further finite data set and an attribute of at least one of the members of the chosen subset of the set of all fact data sets included in the segment.

14. A data visualisation computer program as claimed in claim 10 where the chosen subset of the set of all fact data sets is represented by one or more nodes within the representation.

15. A data visualisation computer program as claimed in claim 14 wherein the graphical representation is arranged to create a new circle of nodes on the outer circumference of the graph whenever the graph divides, the number of nodes equal to the number of new segments, and each node in the new circle substantially the same distance from the centre of the graph.

16. A data visualisation computer program as claimed in claim 14 arranged to superimpose contoured data representations around each node in the representation such that each data point is displayed as a local maximum.

17. A method of data visualisation comprising the steps of storing in a data memory one or more fact data sets comprising an identifier and one or more attributes, and one or more finite element data sets wherein the members of each finite data set defines the range of possible values for at least one attribute of at least one fact data set; retrieving one or more data sets from the memory; and displaying a graphical representation of a chosen subset of the set of all fact data sets in the memory as a series of data values.

18. A method of data visualisation as claimed in claim 17 wherein the graphical representation has a substantially circular configuration.

19. A method of data visualisation as claimed in claim 17, wherein the graphical representation comprises a circular graph.

20. A method of data visualisation as claimed in claim 18 further comprising the steps of retrieving one finite data set; and dividing the graphical representation into two or more segments, each segment matching a member of one of the finite element sets and an attribute of at least one member of the chosen subset of the set of all fact data sets.

21. A method of data visualisation as claimed in claim 20 further comprising the steps of retrieving a further finite element data set; and dividing each segment into one or more sub-segments, each sub-segment matching a member of the further finite data set and an attribute of at least one of the members of the chosen subset of the set of all fact data sets included in the segment.

22. A method of data visualisation as claimed in claim 18 further comprising the step of representing the chosen subset of the set of all fact data sets as one or more nodes within the representation.

23. A method of data visualisation as claimed in claim 22 further comprising the step of creating a new circle of nodes on the outer circumference of the graph whenever the graph divides, the number of nodes equal to the number of new segments, and each node in the new circle substantially the same distance from the centre of the graph.

24. A method of data visualisation as claimed in claim 22 further comprising the steps of superimposing contoured data representations around each node in the representation such that each data point is displayed as a local maximum.
